(19) United States
(12) Patent Application Publication
(10) Pub. No.: US 2017/0153136 A1
(43) Pub. Date: Jun. 1, 2017

(54) CLAMP-ON ULTRASONIC FLOW RATE MEASURING DEVICE HAVING AUTOMATIC PIPE THICKNESS MEASURING FUNCTION

(71) Applicant: Min-Chul SHIN, Seoul (KR)

(72) Inventor: Min-Chul SHIN, Seoul (KR)

(73) Assignee: JAIN TECHNOLOGY CO., LTD., Seoul (KR)

(21) Appl. No.: 15/361,425

(22) Filed: Nov. 27, 2016

(30) Foreign Application Priority Data
Nov. 27, 2015 (KR) 10-2015-0166913

(51) Int. Cl. G01F 1/66; G01B 17/02

(52) U.S. Cl. CPC G01F 1/662; G01F 1/667; G01B 17/02

(57) ABSTRACT

A clamp on type of an ultrasonic flow rate-measuring device attached to an outer wall and having an automatic pipe thickness measuring function is disclosed. The ultrasonic flow rate measuring-device includes an automatic pipe thickness measuring function. The ultrasonic flow rate-measuring device is fixed to the outer diameter of a pipe of which the material is known but the thickness is unknown. The ultrasonic flow rate-measuring device adopts a resonant frequency, which generates a maximum voltage level during frequency sweeping through the entire path. Thus, the ultrasonic flow rate-measuring device measures the resonant frequency by using an average resonant frequency through the entire path of an ultrasonic wave, wherein the entire path corresponds to a path in which an ultrasonic wave radiated from one of a pair of ultrasonic transducers passes through one side of a pipe wall and passes inside of the pipe and passes through the other side of the pipe wall to the other one of the pair of ultrasonic transducers, thereby accurately measuring the thickness of a pipe even when an actual thickness of a pipe is changed by solid sludge or any other contamination. Both sides of the pipe wall correspond to thickness portions of the pipe. The ultrasonic flow rate-measuring device accurately determinates an inner area of pipe conduit by automatically inputting a previously measured actual pipe thickness to a flow calculating equation, so that accuracy of flow measurement is enhanced. It should be noted that the present invention is suitable for an actual field situation where various kinds of contaminations in the pipe exist.

The present application is a US national application and claims the benefit of prior filed Republic of Korea patent application serial number No. 10-2015-0166913 filed 27 Nov. 2015, and said prior application being incorporated herein by reference in its entirety.

### TECHNICAL FIELD

The present invention relates to a clamp-on ultrasonic flow rate measuring device which automatically measures the thickness of a pipe, and more particularly, to a clamp-on ultrasonic flow rate measuring device capable of performing automatic pipe thickness measuring and setting a flow rate measuring device by using a measured pipe thickness value, the clamp-on ultrasonic flow rate measuring device being installed on an existing pipeline and automatically measuring the thickness of a pipe and inputting a measured thickness value to the flow rate measuring device.

### BACKGROUND

A clamp-on ultrasonic flow rate measuring device means an ultrasonic flow rate measuring device that can be placed on the outside on a suitable line section as shown in Korean Registered Patent No. 10-1302645. As disclosed in Korean Registered Patent No. 10-1302645, a clamp-on ultrasonic flow rate measuring device comprises an ultrasonic transducer attached to an outer wall of a pipe, for transmitting an ultrasonic wave to the inside of the pipe and for receiving the ultrasonic wave from the inside of the pipe, and a flow rate detecting control portion to control a flow rate detecting process using a signal detected by the ultrasonic transducer, and a flow rate data calculating portion for calculating flow rate data. The clamp-on ultrasonic flow rate-measuring device can be placed on various kinds of pipes. The existing pipes can have different thicknesses as well as different materials and diameters.

However, as in the conventional clamp-on ultrasonic flow rate measuring device, because the accurate thickness information is unknown by the user, the user should carry a separate pipe thickness measuring device for measuring pipe thickness and input measured thickness value into the ultrasonic flow rate measuring device.

Further, as described in paragraph nos. 0007-0008 of the above publication, “. . . in case of dry and single line type of ultrasonic flow rate measuring device, because a pair of ultrasonic transducers are attached to the upper class and the lower class respectively, the distance between the ultrasonic transducers could be measured. However, as in case of the ultrasonic flow rate measuring device installed to outer wall of pipe, it is difficult to know accurate inner diameter value of pipe unless the user blocks fluid flow and measure inner diameter of pipe. Generally, as the pipe diameters are given by 0.1 mm scale, the suggested diameter values given in the standard are used as pipe inner diameter. However, there are problems in this conventional method in that measuring of actual pipe diameter is not performed, and the actual pipe inner diameter could be reduced by the contamination of pipe inside indeed. To measure actual pipe diameter, fluid flow should be blocked and clean cross section of pipe. However, in the actual working environment, obeying these kinds of process and measuring the flow rate are not easy . . .”

To measure the pipe thickness, an ultrasonic thickness-measuring device is used. The ultrasonic thickness-measuring device is a device to measure thickness of specimen using ultrasonic wave, and it is separated as resonant type and pulse reflection type. The resonant type obtain thickness by measuring resonant frequency, as the ultrasonic wave resonated when the wavelength is integer multiple of half-wave length.

The pulse reflection type of ultrasonic thickness meter measures propagating time to travel back and forth the specimen by the ultrasonic wave. Recently, pulse echo type is used widely. This type is a kind of pulse reflection type devices and display round trip time of ultrasonic wave from measurement surface to the bottom echo.

However, because these kinds of ultrasonic thickness measuring device measure thickness at only one point of region, and due to contamination of inside pipe wall, quite big difference between overall actual thickness of pipe and measured thickness in one point could be occur.

### SUMMARY OF THE INVENTION

Thus, it is an object of the present invention to provide a clamp-on ultrasonic flow rate measuring device having an automatic measuring function for pipe thickness, which can measure the resonant frequency using entire path for which ultrasonic wave propagates during frequency sweeping, wherein the entire path includes a path of which ultrasonic wave radiated from one ultrasonic transducer goes through one side of pipe wall, a path of which the ultrasonic wave passes inside of pipe, a path of which the ultrasonic wave goes through from the other side of pipe wall to the other ultrasonic transducer, so that it can measure thickness of pipe accurately even when actual thickness of pipe has been changed by solid sludge or any other contamination, when the ultrasonic flow rate measuring device is fixed to outer diameter of pipe of which the material is known but the thickness is unknown.

Therefore, according to the present invention, it is provided that clamp-on ultrasonic flow rate measuring device which is fixed to outer diameter of pipe having automatic pipe thickness measuring function comprising,

a mapping table 100 for mapping a pipe thickness to a frequency by measuring a resonant frequency obtaining a maximum voltage level by resonance with respect to a plurality of pipes having different thicknesses for same outer diameter, material, and measuring frequency;

a frequency sweeping portion 104 for sweeping and outputting a frequency within ±30% of the measuring frequency of the ultrasonic transducer 102;

a pair of ultrasonic transducers 102 for radiating an ultrasonic wave and receiving the ultrasonic wave by using the frequency signal input from the frequency sweeping portion 104, wherein the ultrasonic wave radiated from one of the ultrasonic transducers 102 passes one side of a pipe wall, inside of the pipe, and other side of the pipe wall, and reaches the other one of the ultrasonic transducers;

a voltage level measuring portion 106 for measuring a voltage level of the ultrasonic signal received by the ultrasonic transducers 102;

a resonant frequency determining portion 110 for determining a resonant frequency to obtain a maximum voltage level by the voltage level measuring portion 106 when the frequency sweeping portion 104 sweeps the frequency from a high frequency to a low frequency; and

a pipe thickness determining portion 120 for determining a pipe thickness (TH) by using the outer diameter of the pipe and pipe material information input by a user and the resonant frequency determined by resonant frequency determining portion 110 and by referring to the mapping table 100.

### ADVANTAGEOUS EFFECTS OF THE INVENTION

The clamp-on ultrasonic flow rate measuring device having an automatic measuring function according to the invention can measure flow rate of pipe, which is already placed having various outer diameters and materials and thickness without separate thickness meter, when the ultrasonic flow rate measuring device is fixed to outer diameter of pipe of which the material is known but the thickness is unknown.

The present invention determine resonant frequency using entire path for which ultrasonic wave propagates during frequency sweeping, wherein the entire path includes a path of which ultrasonic wave radiated from one ultrasonic transducer goes through one side of pipe wall, a path of which the ultrasonic wave passes inside of pipe, a path of which the ultrasonic wave goes through from the other side of pipe wall to the other ultrasonic transducer, so that it can measure thickness of pipe accurately even when actual thickness of pipe has been changed due to solid sludge or any other contaminations.

### BRIEF DESCRIPTION OF THE DRAWINGS

FIG. 1 is a block diagram illustrating structures of pipe thickness automatic measuring device for clamp-on of ultrasonic flow rate measuring device according to an embodiment of the present invention.

FIGS. 2 and 3 are schematic diagrams explaining the operation of pipe thickness automatic measuring device for clamp-on ultrasonic flow rate measuring device according to an embodiment of the present invention.

FIG. 4 shows an equation for calculating a flow rate in the thickness automatic measuring device for clamp-on of ultrasonic flow rate measuring device according to an embodiment of the present invention.

FIG. 5 shows an equation for calculating the area of FIG. 4 using determined thickness value by the thickness automatic measuring for clamp-on of ultrasonic flow rate measuring device according to an embodiment of the present invention.

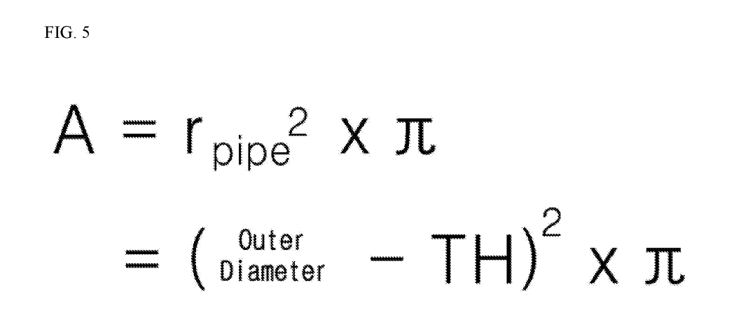

### DETAILED DESCRIPTION OF THE EMBODIMENTS

Referring to attached drawings, the embodiment is explained more specifically here after.

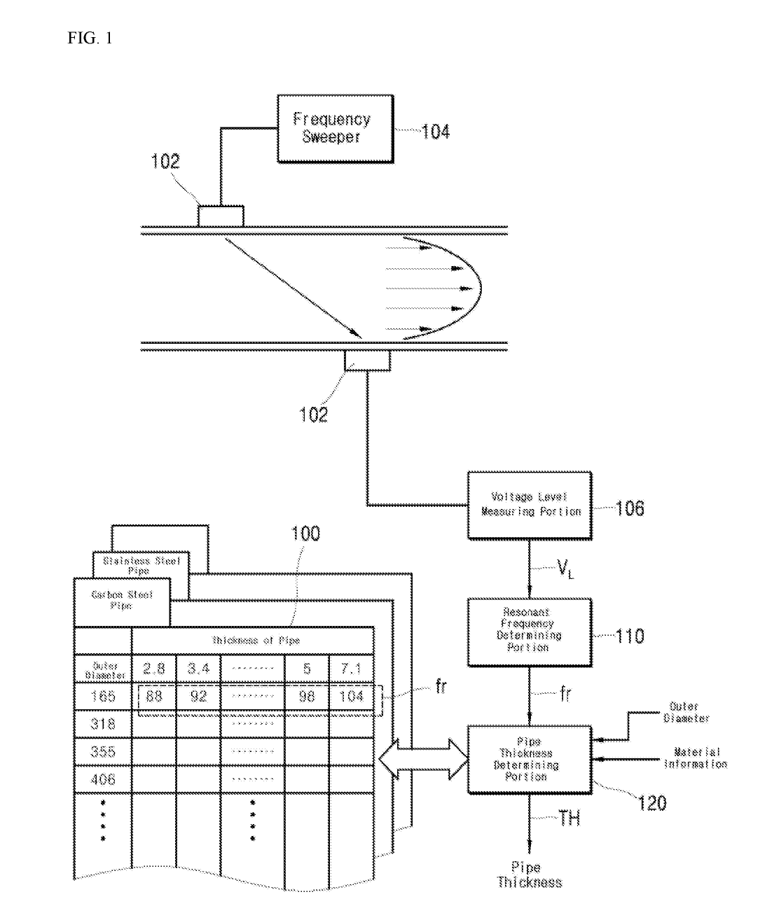

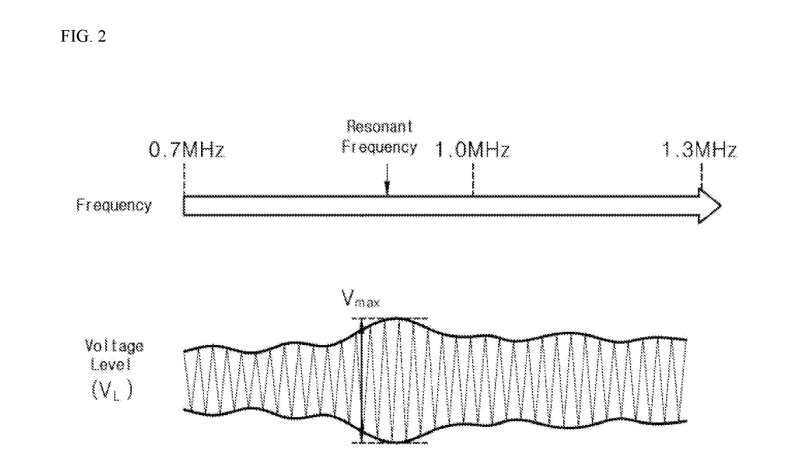

FIG. 1 is a block diagram illustrating structures of pipe thickness automatic measuring device for clamp-on of ultrasonic flow rate measuring device according to embodiment of the present invention. FIGS. 2 and 3 are schematic diagrams explaining the operation of pipe thickness automatic measuring device for clamp-on of ultrasonic flow rate measuring device according to embodiment of the present invention.

Referring to FIG. 1, pipe thickness automatic measuring device for clamp-on of ultrasonic flow rate measuring device according to embodiment of the present invention comprises a mapping table 100 for querying a mapping between a pipe thickness and a resonant frequency for a certain same outer diameter, material, and same measuring frequency range, wherein the resonant frequencies are determined as frequencies to be obtained maximum voltage level.

The mapping table 100 is one embodied as form of memory region in a programmed microcomputer, experimented resonant frequencies(fr) are mapped with respected to different each pipe thickness.

Frequency sweeping portion 104 sweeps frequency of output signal within ±30% of measuring center frequency for the ultrasonic transducer 102.

As for a pair of ultrasonic transducers 102, ultrasonic wave radiated using frequency signal by the frequency sweeping portion 104 from one ultrasonic transducer 102 passes one side of pipe wall, further passes inside of pipe and the other side of pipe wall, and finally reaches to the other ultrasonic transducer 102, so that the other ultrasonic transducer 102 receive the radiated ultrasonic waves.

Voltage level measuring portion 106 measure voltage level of the ultrasonic signal received by the ultrasonic transducer 102, resonant frequency determining portion 110 determine a frequency to obtain a maximum voltage level by the voltage level measuring portion 106 during sweeping from higher frequency to lower frequency by the frequency sweeping portion 104.

For example, as shown in FIG. 2, when measuring frequency of ultrasonic transducer 102 is 1 MHz, voltage level VL is measured during sweeping frequency in region of 700 MHz −1.3 MHz which is ±30% of the measuring frequency, then the frequency is determined as resonant frequency when it represents highest voltage level (Vmax).

Outer diameter and material information of pipe is input into the pipe thickness determining portion(120) by user, and the pipe thickness determining portion(120) obtains pipe thickness(TH) by querying the mapping table 100 using the outer diameter, material information of pipe, the resonant frequency determined by the resonant frequency determining portion 120.

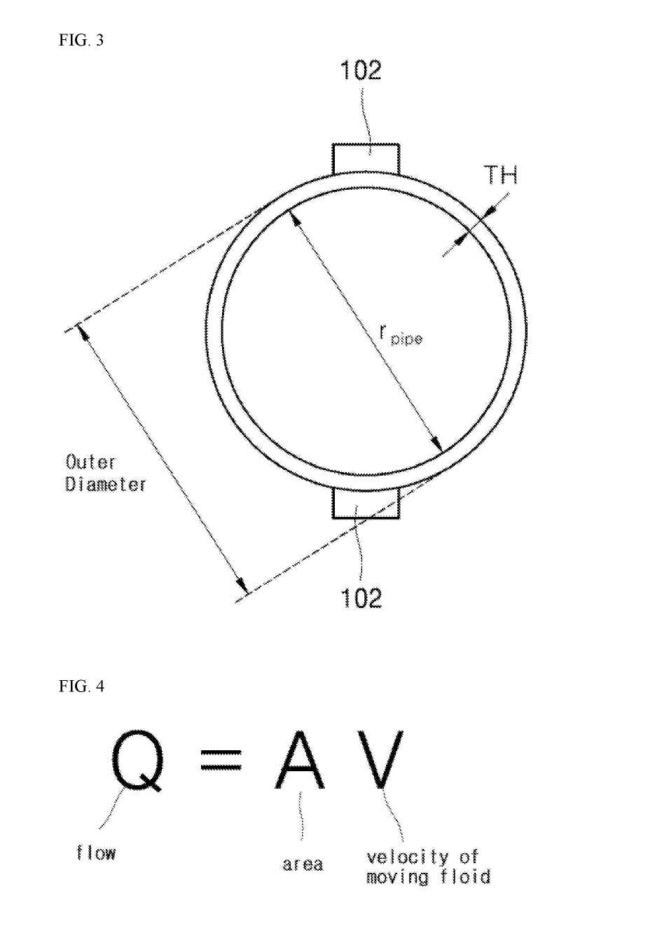

For calculating in the pipe thickness automatic measuring device for clamp-on of ultrasonic flow rate measuring device according to the present invention, as shown in FIG. 4, when Q is flow rate, A is inner area of pipe, V is velocity of fluid, flow rate Q=A*V. Velocity V could be obtained by conventional ultrasonic flow rate measuring device, so further explanation will be omitted.

Inner area of pipe, A, could be calculated from (outer diameter-2rpipe)2×p, if Rpipe is actual inner diameter of pipe, Rpipe could be calculated based on outer diameter and pipe thickness (TH).

Thus, a clamp on type of ultrasonic flow rate measuring device which is attached to outer wall and which has automatic measuring function of pipe thickness is disclosed.

The ultrasonic flow rate-measuring device according to the present invention includes an automatic pipe thickness measuring function. The ultrasonic flow rate-measuring device is fixed to outer diameter of pipe of which the material is known but the thickness is unknown. The ultrasonic flow rate measuring device according to the present invention adopts resonant frequency of which generate maximum voltage level during frequency sweeping through the entire path. Thus, the ultrasonic flow rate measuring device according to the present invention measure the resonant frequency using average resonant frequency through the entire path of ultrasonic wave, wherein the entire path corresponds to path of which ultrasonic wave radiated from one of a pair of ultrasonic transducers goes through one side of pipe wall and passes inside of pipe and goes through the other side of pipe wall to the other one of a pair of ultrasonic transducers, so that it can measure thickness of pipe accurately even when actual thickness of pipe has been changed by solid sludge or any other contamination. Both sides of pipe wall correspond to thickness portions of pipe.

The ultrasonic flow rate-measuring device according to the present invention determinates area of pipe conduit accurately by inputting actual thickness automatically to equation to subsequent flow rate measuring, so that accuracy of flow measurement could be enhanced. It should be noted that the present invention is suitable for actual industrial field where various kinds of contaminations exists in pipe.

Meanwhile, suitable measuring frequency ranges for ultrasonic transducer could be varied with respect to outer diameter and material of pipe to be measured. Therefore, it is more preferred that the mapping table comprises mapping relation between a pipe thickness and a resonant frequency for a certain same outer diameter, material, and same measuring frequency range, wherein the resonant frequency is determined as frequency obtaining maximum voltage level,

While the above description contains many specifics, these should not be construed as limitations on the scope of the invention, but rather as exemplifications of one or another embodiment thereof. Many other variations are possible, which would be obvious to one skilled in the art. Accordingly, the scope of the invention should be determined by the scope of the appended claims and their equivalents, and not just by the embodiments.

What is claimed is:

1. A clamp-on ultrasonic flow rate measuring device fixed to outer diameter of a pipe and having an automatic pipe thickness measuring function, the clamp-on ultrasonic flow rate measuring device comprising:
a mapping table 100 for mapping a pipe thickness to a frequency by measuring a resonant frequency obtaining a maximum voltage level by resonance with respect to a plurality of pipes having different thicknesses for same outer diameter, material, and measuring frequency;
a frequency sweeping portion 104 for sweeping and outputting a frequency within ±30% of the measuring frequency of the ultrasonic transducer 102;
a pair of ultrasonic transducers 102 for radiating an ultrasonic wave and receiving the ultrasonic wave by using the frequency signal input from the frequency sweeping portion 104, wherein the ultrasonic wave radiated from one of the ultrasonic transducers 102 passes one side of a pipe wall, inside of the pipe, and other side of the pipe wall, and reaches the other one of the ultrasonic transducers;
a voltage level measuring portion 106 for measuring a voltage level of the ultrasonic signal received by the ultrasonic transducers 102;
a resonant frequency determining portion 110 for determining a resonant frequency to obtain a maximum voltage level by the voltage level measuring portion 106 when the frequency sweeping portion 104 sweeps the frequency from a high frequency to a low frequency; and
a pipe thickness determining portion 120 for determining a pipe thickness (TH) by using the outer diameter of the pipe and pipe material information input by a user and the resonant frequency determined by resonant frequency determining portion 110 and by referring to the mapping table 100.
